(19) United States
(12) Patent Application Publication
(10) Pub. No.: US 2010/0245478 A1
(43) Pub. Date: Sep. 30, 2010

(54) NOZZLE PLATE MANUFACTURING METHOD AND NOZZLE PLATE

(75) Inventor: Jin Uno, Okazaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/726,995

(22) Filed: Mar. 18, 2010

(30) Foreign Application Priority Data
Mar. 26, 2009 (JP) 2009-075499

(51) Int. Cl. B41J 2/16; B23P 17/00

(52) U.S. Cl. 347/47; 29/890.1

(57) ABSTRACT

A projecting portion is formed on a surface of a liquid droplet discharge side of a substrate in which a plurality of nozzle holes for discharging a liquid droplet will be processed. A liquid droplet formed of a polyimide resin is attached to the vicinity of a portion which will become an opening on the surface of the liquid droplet discharge side of the substrate. Then, the liquid droplet is hardened to form the projecting portion in the vicinity of the portion which will become the opening, and a liquid repellent film is formed on the surface of the liquid droplet discharge side. Thereafter, the nozzle holes are formed on the surface of the liquid droplet discharge side to make up a nozzle surface.

### CROSS REFERENCE TO RELATED APPLICATION

The present application claims priority from Japanese Patent Application No. 2009-075499, filed on Mar. 26, 2009, the disclosure of which is incorporated herein by reference in its entirety.

### BACKGROUND OF THE INVENTION

1. Field of the Invention

The present invention relates to a method for manufacturing a nozzle plate which is utilized in a liquid droplet discharge apparatus such as an ink-jet recording apparatus, and to a nozzle plate.

2. Description of the Related Art

Conventionally, as an ink jet recording apparatus (liquid droplet discharge apparatus), there have been widely known those which carry out recording on a recording medium by discharging inks from nozzle holes of an ink jet head. This kind of ink jet head is provided, in the under portion thereof, with a nozzle plate in which a plurality of nozzle holes from which the inks are discharged are formed. On a nozzle surface which is the under surface of the nozzle plate, a liquid repellent film is formed to prevent the ink(s) from adhering to the nozzle surface (for example, see Japanese Patent Application Laid-Open No. 2005-205601).

Because the nozzle surface faces the recording medium, the nozzle surface and the liquid repellent film formed thereon may be damaged by the recording medium, for example, when the recording medium is bent due to paper jam, etc, and makes a contact with the nozzle surface and the liquid repellent film. It is also conceivable that some foreign substance comes from the outside and gets in contact with the nozzle surface, thereby causing damage to the liquid repellent film. If the nozzle surface and liquid repellent film are damaged around a nozzle hole, or in particular, around an opening of the nozzle hole on the ink discharge side, the ink discharge direction may deviate, or the ink droplet may not be formed in a predetermined manner, etc., thereby failing to perform a normal discharge.

In order to avoid such damage to the liquid repellent film, it is known to form a projecting portion on the nozzle plate per se at positions apart from the nozzle holes (for example, see Japanese Patent Application Laid-Open No. 2006-256165).

In the ink-jet head described in Japanese Patent Application Laid-Open No. 2006-256165, the projecting portion is formed through heat pressing after the nozzle holes are formed. In particular, a press die which has been heated to a high temperature (300° C.) is pressed against the nozzle plate to soften the nozzle plate. Then, the projecting portion is formed in integration with the nozzle plate in such a manner as gathering up the material around the softened portion.

When the projecting portion is formed in this manner through plastic deformation of the nozzle plate per se, variation in thickness may easily occur around a portion at which a nozzle is or is to be formed, and a portion adjacent to the projecting portion. That is, individual variability in thickness tends to occur easily with respect to the nozzle plate, thereby making it difficult to form a desired nozzle. For example, when the nozzle is formed by laser processing after the projecting portion is formed, diameter of a jetting orifice of a nozzle varies depending on the thickness of the nozzle plate. Therefore, it becomes difficult to form the jetting orifice of the nozzle with a high degree of accuracy, and this may thereby affect the ink discharge performance. Further, when the jetting orifice of the nozzle is formed before the projecting portion is formed, variation in thickness occurs easily around the portion at which the nozzle has been formed. As a result, the portion at which the nozzle has been formed may deviate from a desired position.

Further, if the projecting portion is provided at a position apart from the nozzle hole for a reduction in the influence on the nozzle hole, the nozzle hole cannot be sufficiently protected from paper jam and the like.

Further, an ink jet printer generally carries out a wiping operation, with an appropriate timing, to wipe away the inks which are adhered to the ink droplet jetting surface upon forming image or performing maintenance. By the wiping operation, printing performance of the printer is maintained.

In the ink jet head described in Japanese Patent Application Laid-Open No. 2006-256165, a portion opposite to the portion at which the nozzle is formed with respect to the projecting portion is thin and forms a recessed portion. Therefore, even if attention is paid such that the thickness may not change around the place where the nozzle is formed before and after the pressing, the convexity and concavity are so great with respect to the ink droplet jetting surface that the wiper is hindered from moving smoothly in wiping operation. As a result, the inks tend to remain easily around the projecting portion (for example, around the border between the jetting surface and the projecting portion). Therefore, as described above, the jetting direction of the ink droplet may deviate from a correct direction; this may affect the printing performance.

### SUMMARY OF THE INVENTION

Accordingly, an object of the present invention is to provide a method for manufacturing a nozzle plate on which a projecting portion can be easily formed to prevent a recording medium from contact with a nozzle hole opening on the liquid discharge side without lowering the wiping performance, and to provide the nozzle plate.

According to a first aspect of the present invention, there is provided a nozzle plate manufacturing method for manufacturing a nozzle plate in which a plurality of nozzle holes are formed, the method including: adhering a plurality of liquid droplets formed of polyimide resin to one surface of a substrate at portions in the vicinity of portions which are provided for formation of the nozzle holes; hardening the liquid droplets to form projecting portions; forming a liquid repellent film on the one surface of the substrate; and forming the nozzle holes through the substrate.

According to a second aspect of the present invention, there is provided a nozzle plate having a plurality of nozzle holes, including: a resin substrate having a surface on which hydrophilic process is performed; a plurality of projecting portions formed of polyimide resin on the surface of the resin substrate; and a liquid repellent film which covers the surface, of the resin substrate, on which the projecting portions are formed; and the nozzle holes are formed in the vicinity of the projecting portions through the resin substrate and the liquid repellent film.

In this manner, by adhering and hardening a plurality of liquid droplets formed of a polyimide resin, the projecting portion is formed easily and assuredly in the vicinity of each of the nozzle holes to prevent the nozzle hole openings from contact with the recording medium. Further, in comparison with the conventional technologies, thickness does not change in the areas at which the nozzles will be formed. Therefore, it is possible to form the nozzle holes with a high degree of accuracy. Especially, because the projecting portion is formed of a polyimide resin which has excellent affinity for the nozzle plate base material, it is possible to form the projecting portion with a base shaped into a smoothly curved surface. Accordingly, the projecting portion is smoothly connected with the flat nozzle surface. Further, since the base of the projecting portion is shaped into a smoothly curved surface, the wiper can move along the smoothly shaped surface to wipe away liquid droplets. As a result, since the wiping operation is smoothly carried out without being hindered, and liquids do not tend to accumulate easily on the border between the nozzle surface and the base of the projecting portion, the wiping performance is improved. Further, since the projecting portion has a smoothly curved surface, the nozzle surface may not easily get damaged even if the recording medium gets bent or curved due to paper jam and the like to cause its end portion or part of it to make contact with the projecting portion.

Further, since a liquid repellent film is formed on the surface of the projecting portion, it prevents liquids from adhering to the surface of the projecting portion during the time such as the liquids are discharged from the nozzle holes, etc.

### BRIEF DESCRIPTION OF THE DRAWINGS

FIG. 1 is a perspective view showing an overall construction of an ink jet recording apparatus according to an embodiment of the present invention;

FIG. 2 is an illustration diagram showing an ink-jet head and a suction mechanism;

FIG. 3 is a cross-sectional view of the ink jet head;

FIG. 4A is an enlarged view of a nozzle plate base material corresponding to the portion “A” of FIG. 3;

FIG. 4B is a bottom plan view of the nozzle plate base material shown in FIG. 4A;

FIGS. 5A to 5H are illustration diagrams of a nozzle plate manufacturing method in respective processes including a preprocess which is carried out prior to a liquid droplet application process;

FIGS. 6A to 6D are illustration diagrams of the nozzle plate manufacturing method in respective processes; and

FIGS. 7A to 7C are illustration diagrams with respect to a modification of the nozzle plate manufacturing method in respective processes.

### DESCRIPTION OF THE PREFERRED EMBODIMENT

Hereinafter, a preferred embodiment of the present invention will be described in accordance with the accompanying drawings. Further, in the following descriptions, suffixes B, Y, M, and C which are added to each of the numerals indicate members utilized for inks of black, yellow, magenta, and cyan, respectively.

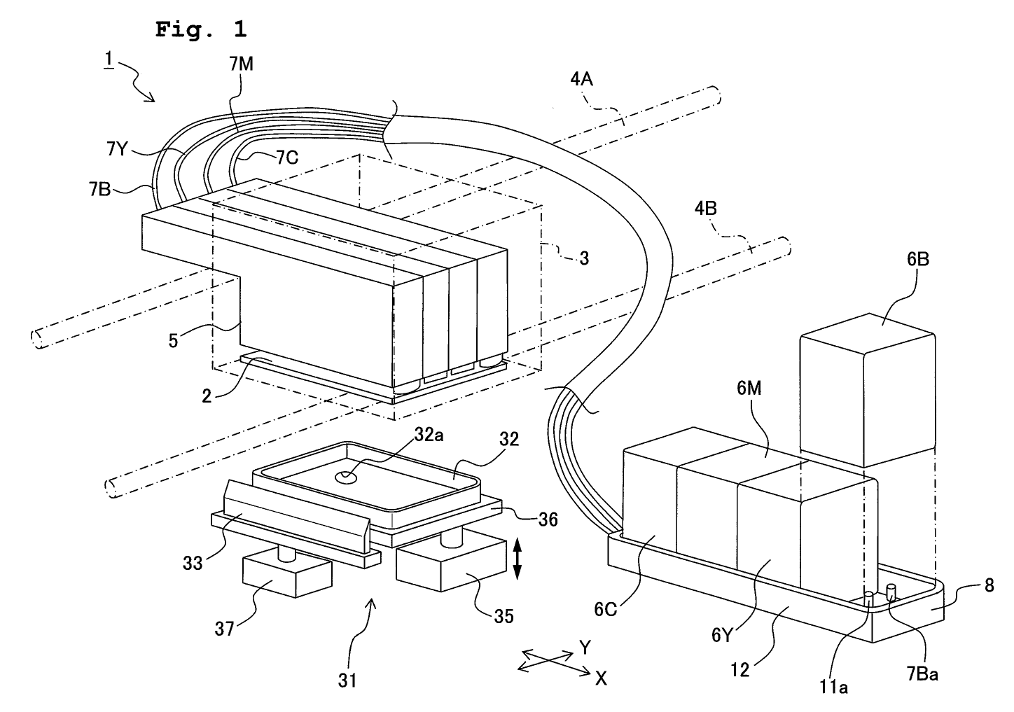

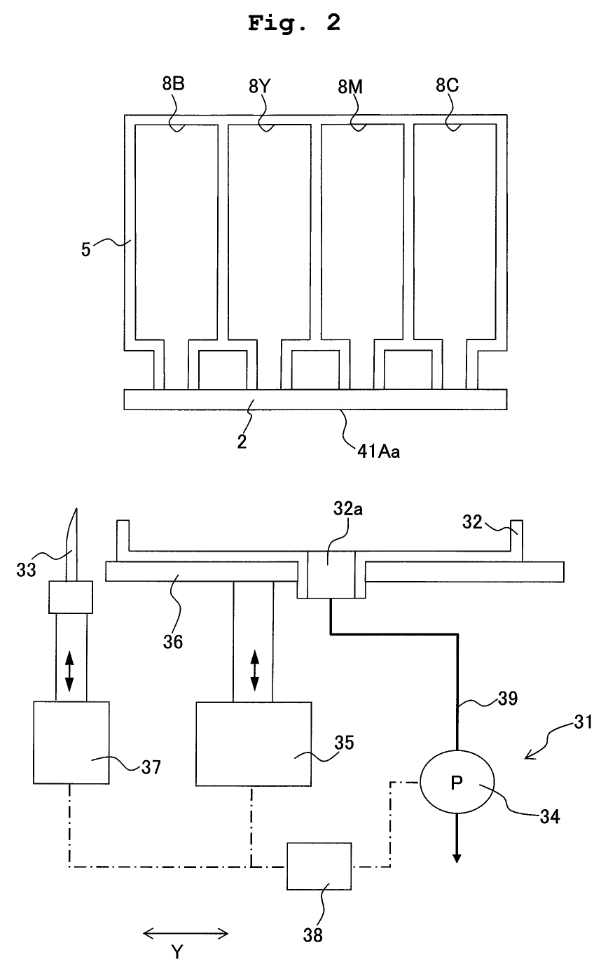

As shown in FIGS. 1 and 2, an ink jet recording apparatus 1 includes an inkjet head 2. The inkjet head 2 is held in a head holder 3 which is supported to be relatively movable to a recording paper as a recording medium (not shown). The ink-jet head 2 has groups of nozzles for discharging different kinds of inks respectively. By virtue of a drive mechanism (not shown), the head holder 3 is supported to be able to reciprocate along guide rails 4A and 4B which extend in the direction “Y” perpendicular to the direction “X” which is a feeding direction of the recording paper. In the head holder 3, an ink tank 5 is provided to supply the inks to the ink-jet head 2.

The ink tank 5 has ink storage chambers 8B, 8Y, 8M, and 8C (see FIG. 2) for storing the different kinds of inks, respectively. To the ink storage chambers 8B, 8Y, 8M, and 8C, the inks are supplied through ink supply tubes 7B, 7Y, 7M, and 7C from ink cartridge 6B, 6Y, 6M, and 6C which are arranged outside the head holder 3, respectively.

Further, as shown in FIGS. 1 and 2, on the moving path of the head holder 3, at a predetermined standby position at which recording on the recording paper is not performed, a recovery mechanism 31 is provided to face the under surface of the head holder 3. The recovery mechanism 31 carries out a purge process for removing air and thickened inks inside the ink jet head 2 to the outside so as to recover the ink discharge performance, and a wipe process for wiping and cleaning away the inks adhering to a nozzle surface 41Aa which will be described later. A suction cap 32 is, as heretofore known, provided to connect with the nozzle surface 41Aa in a detachable manner as the device for carrying out the purge process. A connection opening portion 32a of the suction cap 32 is connected to a suction pump 34 via a suction passage 39. The suction cap 32 is mounted on a movable board 36 which is supported to be able to move up and down by a lifting and lowering device 35.

As the device for carrying out the wipe process, a wiper 33 formed of a plastic blade made of rubber materials and the like is, as heretofore known, provided to detachably contact with the nozzle surface 41Aa. The wiper 33 is moved up and down by a lifting and lowering device 37.

The suction pump 34 and the lifting and lowering devices 35 and 37 are all controlled by a controller 38 (see FIG. 2). That is, when the purge process is carried out during ink cartridge replacement or periodic maintenance, the head holder 3 is moved to the position facing the recovery mechanism 31, and then the lifting and lowering device 35 is driven to attach the suction cap 32 tightly to the nozzle surface 41Aa of the ink jet head 2. In this state, by driving the suction pump 34 which communicates with the suction cap 32 for a certain period of time, the air and thickened inks inside the ink-jet head 2 are removed to the outside. The suction cap 32 is made of a resin and has an approximate box shape having an opening on the upper side to enclose the nozzle-formed area of the nozzle surface 41Aa. Further, edge portion of the suction cap 32 is curved up to contact with the nozzle surface 41Aa such that the suction cap 32 is attached tightly to the nozzle surface 41Aa. Thereafter, the lifting and lowering device 35 is driven to detach the suction cap 32 from the nozzle surface 41Aa, and the lifting and lowering device 37 is driven to elevate the wiper 33, which extends over a long distance in the X direction and is formed such that its edge portion becomes thin and flexible. Then, the head holder 3 is moved toward the recording paper side to allow the edge of the wiper 33 to contact with the nozzle surface 41Aa, and then moved in the Y direction to wipe and clean away the inks which have adhered to the nozzle surface 41Aa after the purge process.

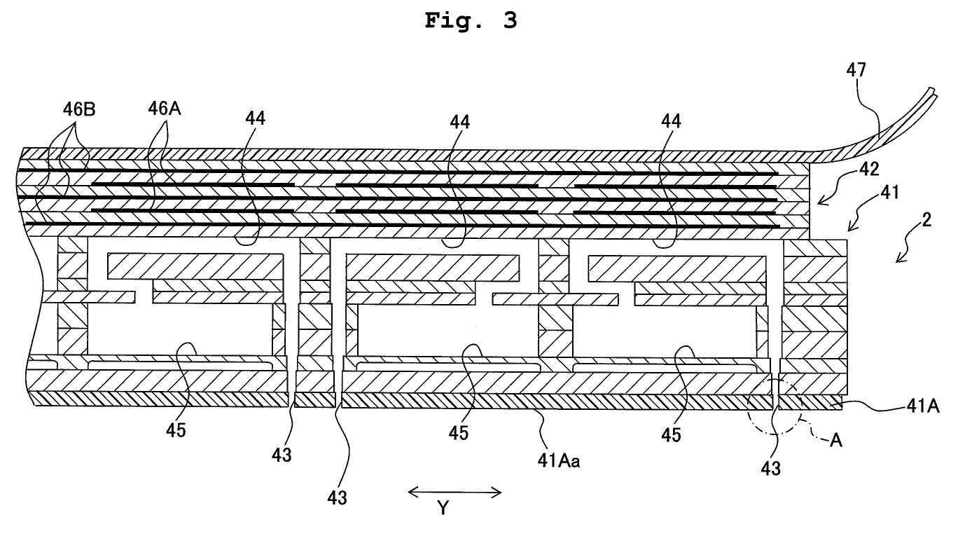

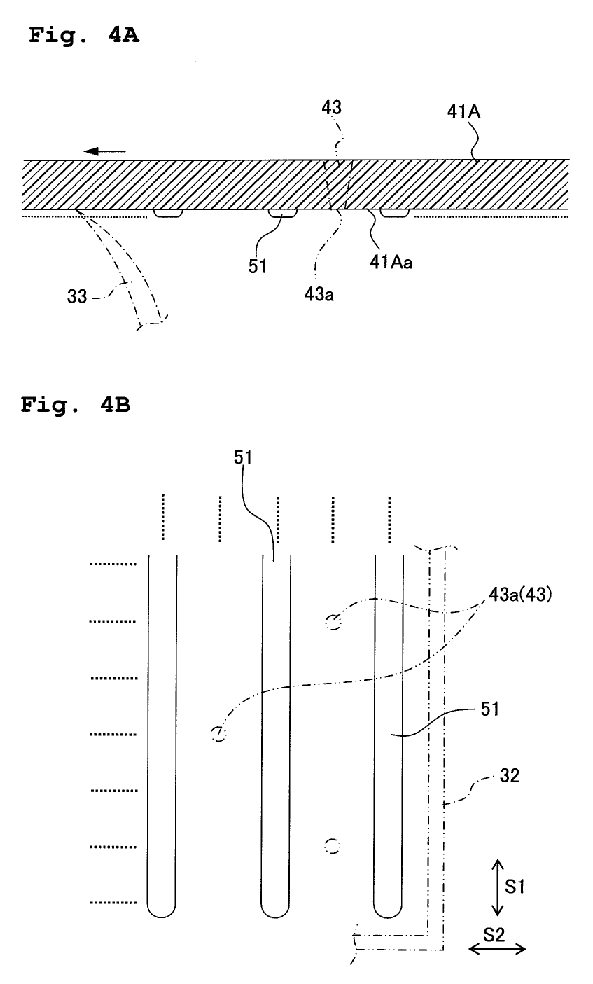

As shown in FIG. 3 in detail, a piezoelectric actuator 42 is stacked on a cavity unit 41 to construct the ink-jet head 2. The cavity unit 41 is formed by stacking a plurality of plates including a nozzle plate 41A, has a plurality of pressure chambers 44 which communicate with a plurality of nozzle holes 43 in a one-to-one manner and which are arranged in a matrix form, and is provided with common ink chambers 45 for supplying the inks to each row of the pressure chambers 44. Further, the plurality of nozzle holes 43 are formed as a plurality of rows each extending in the X direction (the nozzle row direction S1 in FIG. 4B) and the nozzle rows are arranged in the “Y” direction (the direction S2 in FIG. 4B).

On the upper surface of the cavity unit 41, there are ink supply ports (not shown) which open according to the colors of the different inks respectively. The inks are introduced from the ink supply ports to the common ink chambers 45 respectively, and distributed from the common ink chambers 45 to the plurality of pressure chambers 44. The inks pass through an ink flow passages 48 (liquid flow passage) via the pressure chambers 44, and reach the nozzle holes 43. The piezoelectric actuator 42 is formed by stacking a plurality of plate-shaped ceramic sheets and sandwiching therebetween individual electrodes 46A which correspond to the pressure chambers 44 respectively, and common electrodes 46B which are common to all of the pressure chambers 44, alternately. The ceramics between the electrodes 46A and 46B act as drive portions which deform due to the piezoelectric effect. These drive portions are arranged in a plane state to correspond to the pressure chambers 44, and configured to discharge the inks from the nozzle holes 43 by selectively driving each of the drive portions.

On the upper surface of the piezoelectric actuator 42, a number of connection terminals (not shown) in electric connection with each of the drive portions are arranged in a matrix form. A flexible wiring board 47 which has a wiring pattern for connection to the connection terminals is fixed in such a state as being stacked on and parallel to the upper surface of the piezoelectric actuator 42.

The cavity unit 41 has the nozzle plate 41A on the under surface. As shown in FIGS. 4A and 4B in an enlarged manner, the nozzle plate 41A is provided with a plurality of (or a plurality of rows of) projecting portions 51 which have certain height and a base smoothly shaped on the nozzle surface 41Aa on a side that the plurality of nozzle holes 43 are opened for discharging the inks toward the ink discharge object medium. These projecting portions 51 are arranged along the row direction of the nozzle holes 43 to prevent the recording paper from direct contact with the nozzle surface 41Aa due to paper jam and the like, thereby fulfilling the function of avoiding damage, caused by such contact, to the nozzle surface 41Aa and a liquid repellent film which will be described later.

Each of the projecting portions 51 is greater in width than a diameter, of each of the nozzle holes 43, which is about 20 μm. Each of the projecting portions 51 projects about 5 to 20 μm from the nozzle surface 41Aa, and is provided between the rows of the nozzle holes 43. Further, as shown in FIG. 4B, each of the projecting portions 51 extends in the nozzle row direction S1 in a linear shape. In particular, between all the nozzle rows, a plurality of linear projecting portions 51 extending in the nozzle row direction Si are provided in the S2 direction. Either one or more than one projecting portion(s) 51 may be provided between every two nozzle rows. In this manner, since the plurality of linear projecting portions 51 are provided between all the nozzle rows, it is possible to prevent the recording paper from contact with any portion of the nozzle surface 41Aa.

Further, as shown in FIG. 4B, during the purge process, the hollow suction cap 32 connects with the nozzle surface 41Aa of the nozzle plate 41A in a detachable manner to cover the nozzle holes 43. At this time, the projecting portions 51 are located inside the suction cap 32 apart from where the edge portion of the suction cap 32 is attached tightly to the nozzle surface 41Aa. Since the nozzle surface 41Aa to which the suction cap 32 is tightly attached is a flat surface, its connection with the suction cap 32 is not impaired. Further, the wiper 33 carries out a wiping process to wipe away the inks which have adhered to the nozzle surface 41Aa after the purge process. At this time, since the projecting portion 51 does not rise sharply or suddenly from the nozzle surface 41Aa along the outer surface such that a smoothly connected base is shaped, the wiper 33 can move smoothly along the projecting portion 51 to wipe the nozzle surface 41Aa without being hindered by the projecting portion 51. Further, since the base of the projecting portion 51 is in smooth connection with the flat nozzle surface 41Aa, the wiped-off inks do not tend to accumulate easily around the border between the base and the nozzle surface. Therefore, the wiping performance is secured.

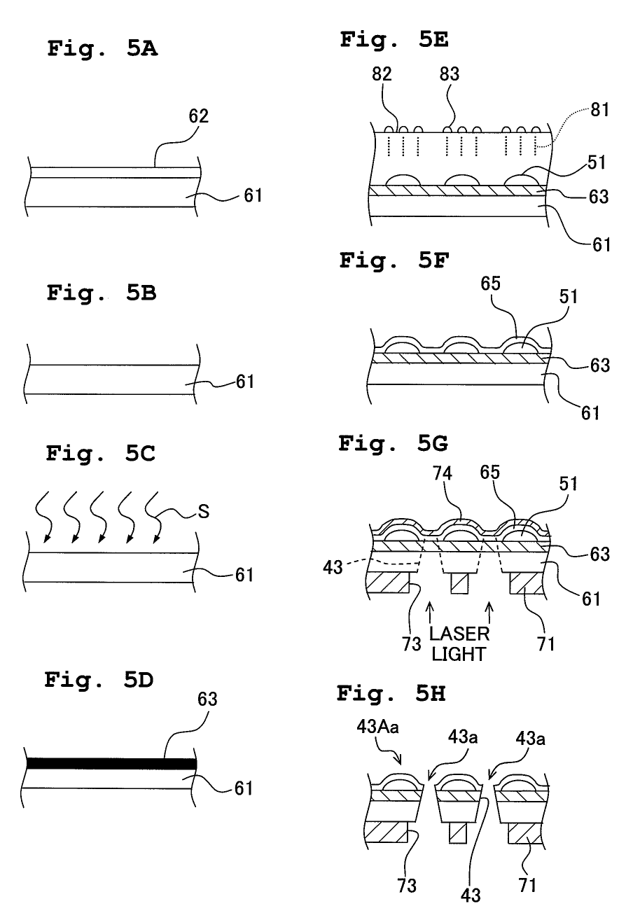

Next, explanations will be given, utilizing FIGS. 5A to 5H, with respect to the method for manufacturing the nozzle plate 41A by forming the projecting portions 51 on a nozzle plate base material in which nozzle holes are not formed. Here, the nozzle plate base material is not formed with a plurality of nozzle holes for discharging inks A number of such nozzle plate base materials are allocated to a resin plate base material 61 formed of a large-sized polyimide resin (in particular, a polyimide resin film); and a plurality of nozzle plates are taken out of the resin plate base material 61 respectively through processes such as pressing, etching, and the like after a post-process is undergone.

A preprocess, which is carried out prior to a liquid droplet adhering process for adhering a liquid droplet to form the projecting portion, is explained below. On the surface of the resin plate base material 61 formed of a polyimide resin, a low molecular weight composition which composes the polyimide is separated in the process of manufacturing the resin plate base material 61; in other words, a so-called brittle layer 62 is formed. As a result, if the projecting portions 51 and liquid repellent film are provided thereon, they are detached easily because sufficient adhesion strength cannot be acquired. To address this problem, as shown in FIG. 5A, the brittle layer 62 of polyimide resin is removed from the surface of the resin plate base material 61 on the side that the nozzle holes 43 will be formed to discharge ink droplets by immersing the resin plate base material 61 in a strong alkaline aqueous solution (a common strong alkaline aqueous solution such as aqueous sodium hydroxide and the like), or applying the strong alkaline aqueous solution to the resin plate base material 61 (see FIG. 5B). Then, the resin plate base material 61 is washed thoroughly with water and dried (cleaning process). Thus, the brittle layer 62 is dissolved away by cleaning with the alkaline solution; thereby, improvement of adhesion strength can be expected. Here, the utilized strong alkaline aqueous solution is a common strong alkaline aqueous solution such as aqueous sodium hydroxide and the like. However, it should not be specifically limited to this.

Following the cleaning process, as shown in FIG. 5C, a surface hydrophilic process is carried out with respect to the surface from which the brittle layer 62 of the resin plate base material 61 is removed. That is, an atmospheric pressure plasma process S is applied to the surface (hydrophilic process). The hydrophilic process prior to primer application is carried out to improve the adhesion between a primer and the resin plate base material 61 for the following process, utilizing a low damage method such as the atmospheric pressure plasma process S which protects the base material surface from being easily damaged.

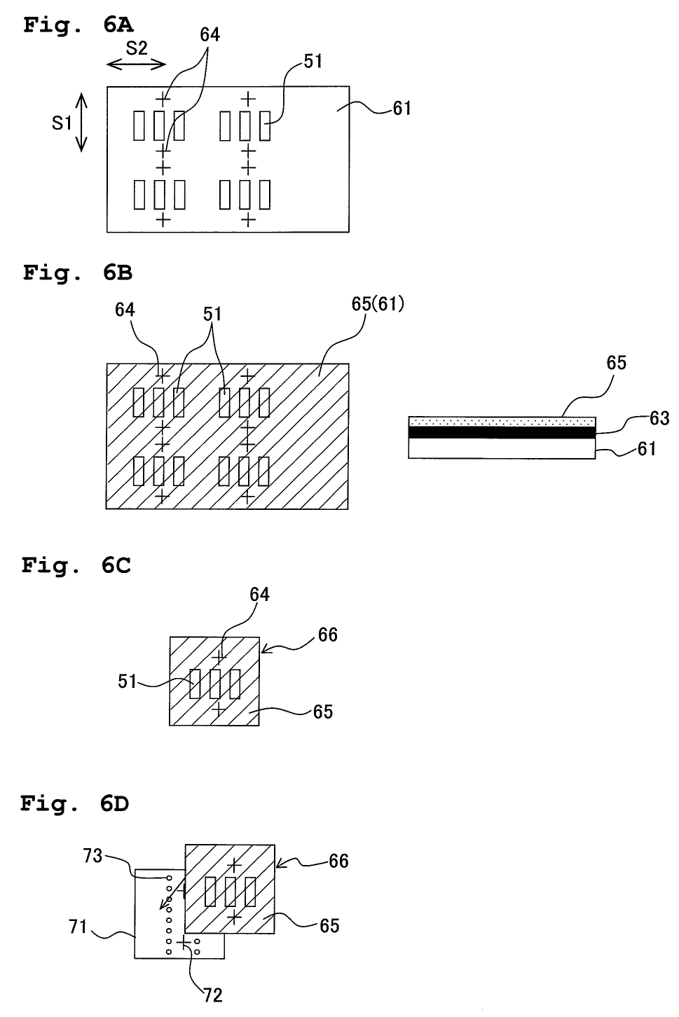

As shown in FIG. 5D, following the hydrophilic process, a primer is applied to, or a primer solution is used to immerse therein, the surface of the resin plate base material 61 which has undergone the hydrophilic process, so as to form a primer layer 63 (primer layer formation process). With this, it is possible to further improve the adhesion strength between the projecting portions 51 with a liquid repellent film, and the resin plate base material 61 for the following process. Hence, it is possible to form the projecting portions 51 and liquid repellent film which do not peel or come off even if there is a frictional contact between the recording paper and the nozzle surface due to, for example, paper jam and the like, or a chemical attack from the inks Here, a silane coupling agent KBE-903 manufactured by Shin-Etsu Chemical Co., Ltd., for example, is diluted with pure water to about 2 wt % to serve as the primer, and dried at about 100° C. Next, as shown in FIGS. 5E and 6A, a liquid discharge method is utilized to form the projecting portions 51 on the surface which is on the side that the ink droplets are discharged from the nozzle holes 43 and which is of the resin plate base material 61 which has undergone the above primer process (liquid droplet application process). The projecting portions 51 are adhered to the primer layer 63 at portions in the vicinity of portions provided for formation of openings 43a of the nozzle holes 43 in a later process on the ink droplet discharge side, by discharging resin liquid droplets 81 formed of a polyimide resin from discharge holes 83 of a liquid droplet discharge device 82. At this time, as shown in FIG. 5E, one projecting portion 51 is formed by discharging the liquid droplets 81 from a plurality of discharge holes 83 of the liquid droplet discharge device 82. Here, though not specifically shown, the liquid droplets 81 are consecutively adhered to and hardened on the surface of the primer layer 63 along the rows of the portions which will become the openings 43a so as to form the linear projecting portions 51 each of which consecutively extends in the nozzle row direction S1 and which has width in the direction S2. Here, the liquid droplets are applied such that the liquid droplets which will become respective projecting portions 51 are applied once in one scan to the portion corresponding to one nozzle plate which will be the final product so as not to cause unevenness in formation of the projecting portions 51. For example, in FIGS. 5E and 6A, one group of three projecting portions 51 is formed on the portion corresponding to one nozzle plate; the liquid droplets are applied with the same timing in the longitudinal direction of the projecting portions to form each group of the projecting portions 51.

By printing according to the liquid droplet discharge method for discharging the liquid droplets from a plurality of discharge holes 83 arranged in the S2 direction (for example, 40 μm in hole diameter and 70 μm in hole pitch, approximately), the polyimide resin is discharged in liquid droplet form with a predetermined pattern on one surface of the resin plate base material 61. Thereby, as described hereinbefore, it is possible to adhere the resin liquid droplets to the positions which do not interfere with the suction cap 32. In other words, the projecting portions 51 are not formed at a portion to which the suction cap 32 is connected. Further, even if there is a problem in discharge from any of the discharge holes 83, the resin drops can be discharged from another discharge hole 83 to compensate.

Further, in printing according to this liquid droplet discharge method, as shown in FIG. 6A, positioning marks 64 for nozzle hole processing are printed together with the projecting portions 51. These positioning marks 64 are utilized to determine positions for attaching the nozzle plate having the projecting portions 51 to a metallic member 71 in a later process for attaching the nozzle plate base material having the projecting portions 51 to the metallic member 71 to carry out the nozzle hole process. The metallic member 71 is correctly positioned with the projecting portions 51 by the positioning marks 64 and is attached to the nozzle plate base material. As the details will be described hereinafter, because the nozzle holes are formed through laser processing via the holes of the metallic member 71, the holes of the metallic member 71 function as the positioning holes for the nozzle holes. Since the metallic member 71 and the projecting portions 51 are correctly positioned with each other, the holes of the metallic member 71, the nozzle holes 43 and the projecting portions 51 are all correctly positioned. Since the positioning marks 64 are formed together with the projecting portions 51, it is possible to improve the precision of nozzle processing and to determine the position correctly. Further, since positional deviation hardly occurs between the nozzle holes and the projecting portions, it is advantageous to providing the projecting portions in the vicinity of the nozzle holes with a high precision. Further, with the positioning marks 64 as fiducial marks, it becomes easy to provide the projecting portions 51 at the positions which do not interfere with the suction cap 32.

Here, although the viscosity of the utilized polyimide resin varies with the discharge capacity of the liquid droplet discharge device utilized in applying the liquid droplets, it is normally 5 to 15 mPa·sec. With that, when a liquid droplet is discharged from a discharge hole 83 at a position apart from the surface of the resin plate base material 61 by about 1 mm, the landed liquid droplet increases in diameter up to about 1.5 times as great as it was just landed, and mixes with another liquid droplet discharged from an adjacent discharge hole 83 to form a projecting portion 51 as great as about 0.25 to 0.30 mm in width.

The nozzle plate 41A is formed of the resin plate base material 61 on which a plurality of nozzle holes 43 are formed in rows. The liquid droplets are applied along the portions which are to be the nozzle rows (the rows of the openings 43a). In this manner, each of the projecting portions 51 is consecutively formed in a linear shape to extend in the row direction at one of middle positions between the portions which are to be the rows of the openings 43a of the nozzle holes 43. Therefore, when three of the liquid droplet discharge holes 83 are arranged in the S2 direction perpendicular to the row direction of the openings 43a, the central discharge hole 83 among the three discharge holes 83 moves in the row direction along the central position between the portions which are to be the rows of the openings 43a in printing.

The projecting portion 51 is formed by discharging a plurality of liquid droplets from the plurality of discharge holes 83, of the liquid droplet discharge device 82, which are arranged in a short (width) direction of the projecting portion 51. Because the projecting portion 51 is required to have a certain height (for example, at least 2.5 μm), it is formed by repeatedly discharging a plurality of resin liquid droplets to a same position according to the liquid droplet discharge method. Even if the plurality of polyimide liquid droplets are applied repeatedly in this manner, the projecting portion formed by the first applied liquid droplets does not extend much in width. Since the subsequent liquid droplets are applied on the first formed projecting portion in the height direction, it is possible to form the projecting portion 51 having a certain height. Therefore, it is possible to carry out the application without utilizing a mask to confine the application portion. That is, it is also possible to omit the utilization of the mask for preventing the liquid droplet from adhering to the inside of the nozzle hole. Further, because the polyimide resin is low in viscosity, a sufficient height cannot be achieved with one application. For example, about 2.5 μm in height can be secured with two applications. In order to secure a height which may assuredly prevent paper jams, it is preferable to form the projecting portions about 5 μm in height with more than three applications.

Further, prior to the liquid droplet application, another process may be added to preheat the resin plate base material 61 with a heating mechanism (not shown). Heating the resin plate base material 61 allows the liquid droplets adhered to the base material surface to be dried quickly, thereby preventing the bases of the projecting portions 51 from extending due to drying slowly.

The liquid droplets are hardened by calcination at a temperature between 250° C. and 300° C. to form the projecting portions 51 with respect to the portions in the vicinity of the portions which are to be the openings 43a (liquid droplet hardening process). That is, the projecting portions 51 are formed along the rows of the portions which are to be the openings 43a. Because the polyimide resin is low in viscosity and the calcination can be carried out at a temperature lower than the conventional 350° C., heat contraction hardly occurs. Then, as shown in FIGS. 5F and 6B, a liquid repellent film 65 is formed by applying a liquid repellent agent made of a fluorinated material by, for example, spraying onto the surface of the liquid droplet discharge side. Then, the liquid repellent film 65 is calcinated at a predetermined temperature, for example, 250° C. (liquid repellent film formation process). In this manner, since the liquid repellent film 65 is formed at the stage that the nozzle holes are not formed, no liquid repellent film will be formed inside each of the nozzle holes of the nozzle plate which is the finial product. Further, since alkaline cleaning, plasma processing and primer processing are performed, adhesion of the projecting portions 51 and the liquid repellent film 65 to the resin plate base material 61 are improved.

Here, the following materials may be utilized to form the liquid repellent film: fluorinated resins such as chlorotrifluoroethylene resin (PCTFE resin), vinylidene fluoride resin, polyvinyl fluoride resin, and the like; and, furthermore, surface modifiers and coating agents including fluorine atoms such as KP801M (product name, manufactured by Shin-Etsu Chemical Co., Ltd.), Cytop (product name, manufactured by Asahi Glass Co., Ltd.), AF1600 (product name, manufactured by E. I. du Pont de Nemours and Company), DEFENNSA77702 (a radical photopolymerization resin, manufactured by DIC Corporation), FS-116 (product name, manufactured by Daikin Industries, Ltd.), Fluorad (product name, manufactured by Sumitomo 3M Limited), and the like.

### (Nozzle Hole Formation Process)

Next, based on the positioning marks 64, as shown in FIG. 6C, the resin plate base material 61 is cut into base materials 66 of a predetermined size. Then, as shown in FIGS. 5G and 6D, the cut-out base material 66 on which the positioning marks 64 are formed is attached to the metallic member 71 formed with a plurality of holes 73 corresponding to the nozzle hole positions by an adhesive, such that the positioning marks 64 are positioned on the positioning marks 72 formed on the metallic member 71, respectively. Here, the metallic member 71 is made of a metal such as an alloy (42% Ni—Fe), a stainless steel, and the like; and attached by an adhesive (for example, 20X-343-12, manufactured by ThreeBond Co., Ltd.).

After that, a surface protection film 74 is attached to the surface on which the projecting portions 52 and the liquid repellent film 65 are formed, and the nozzle holes 43 are formed through laser processing from the back side. Namely, a laser is irradiated from the side of the surface to which the metallic member 71 is attached. Then, the surface protection film 74 is detached. For example, excimer laser may be utilized in the laser processing (see FIG. 5H).

The surface protection film 74 is attached to the liquid repellent film 65 prior to the laser processing in order to prevent the scattered carbon powders, airborne droplets of the nozzle plate base material, and the like which are produced in forming the nozzle holes 43 through the laser processing, from adhering to the liquid repellent film 65 and inhibiting the liquid repellency of the liquid repellent film 65. Accordingly, in forming the nozzle holes 43, the laser processing energy is regulated such that the laser lights are radiated to form the nozzle holes in the nozzle plate base material but stopped at the inside of the surface protection film 74, thereby not penetrating therethrough. Thus, because the surface of the liquid repellent film 65 is sealed up with the surface protection film 74, the carbon powders and airborne droplets produced in forming the nozzle holes 43 will not adhere to the liquid repellent film 65.

When the surface protection film 74 is attached to the liquid repellent film 65 with the projecting portions 51 formed thereunder, if the projecting portions 51 are shaped as the conventional ones, for example, being angular or not smooth, the surface protection film 74 cannot be attached tightly to the border portions between the base portions of the projecting portions 51 and the flat surface of the nozzle plate base material. Therefore, air layers will be formed therebetween. Since the border portions are adjacent to the positions at which the nozzle holes will be formed, the nozzle hole formation areas fall into portions at which the air layers exist. In such a state, if the nozzle holes 43 are formed through the laser processing, the carbon powders and airborne droplets produced in manufacturing will come into the air layers to be enclosed in between the liquid repellent film 65 and the surface protection film 74. Hence, in this state, even if the surface protection film 74 is detached, the carbon powders and airborne droplets still remain on the liquid repellent film 65, thereby inhibiting the liquid repellency of the liquid repellent film 65.

However, according to the present invention, since the projecting portions 51 have smooth bases made of polyimide resin, the surface protection film can be attached tightly to the liquid repellent film without air layers coming in therebetween. Therefore, the liquid repellency will not be inhibited by the carbon powders and airborne droplets which, in the above case, remain on the liquid repellent film.

As shown in FIG. 5H, the openings 43a of the nozzle holes 43 are formed on the surface of the liquid droplet discharge side to make up the nozzle surface 43Aa. Further, the metallic member 71 becomes a component member of the cavity unit 41, and stacked on the back side of the nozzle plate 41A. If a plate provided with the holes which compose the ink flow passage 48 is used as the metallic member 71, it is not removed but utilized as a component member of the cavity unit 41, and the plurality of holes 73 become the holes which compose the ink flow passage 48. In addition, other plates are further stacked to form the cavity unit 41.

As described above, the projecting portions are formed by adhering liquid droplets of a polyimide resin to the surface, of the nozzle plate base material, on which the nozzle hole openings will be formed. Therefore, it is possible to easily and assuredly form the projecting portion in the vicinity of each of the nozzle holes for preventing the nozzle surface from contact with a recording medium. Further, in comparison with the conventional technologies, since the thickness does not change in the areas where the nozzles will be formed, it is possible to form the nozzle holes with a high precision even after the projecting portions are formed. Especially, since the projecting portion is formed by utilizing a polyimide resin which has such a property as is excellent in affinity for the base material, it is possible to form the projecting portion with a base shaped into a smoothly curved surface so as to be in smooth connection with the flat nozzle surface. By forming the projecting portions with smoothly shaped bases, the wiper can move along the smoothly shaped projecting portions to wipe away the liquid droplets, thereby allowing a smooth wiping operation. Further, since the liquids do not easily accumulate on the borders between the nozzle surface and the bases of the projecting portions, the wiping performance is improved. Further, since the projecting portion has a smoothly curved surface, the nozzle surface may not easily get damaged even if the recording medium gets bent or curved due to paper jam, and the like, to cause its end portion or part of it to make contact with the projecting portion. Besides, since a liquid repellent film is also formed on the surface of the projecting portions, it prevents liquids from adhering to the surface of the projecting portions during the time such as the liquids are discharged from the nozzle holes, etc.

Further, modifications may also be applied to the above embodiment in carrying out the present invention as follows.

A resin plate base material formed of a polyimide resin is utilized for the nozzle plate base material. However, resin plate base materials formed of other resins are, of course, also applicable. Furthermore, metallic plate base materials may also be applied.

In the embodiment, the projecting portion 51 is shaped with a base which has a smoothly curved surface. However, the present invention is not limited to this but may apply any shapes such that the recording paper may not easily get in direct contact with the liquid repellent film 65 of the nozzle surface 41Aa, and the wiping performance may be secured. Further, each projecting portion may be different in shape and size.

In the embodiment, the projecting portions 51 are consecutively formed in a linear shape. However, they are not necessarily shaped in this manner but may be formed in a dashed-line shape (to intermittently have linear portions), or be formed such that chevron-shaped projecting portions are arranged densely with a short pitch.

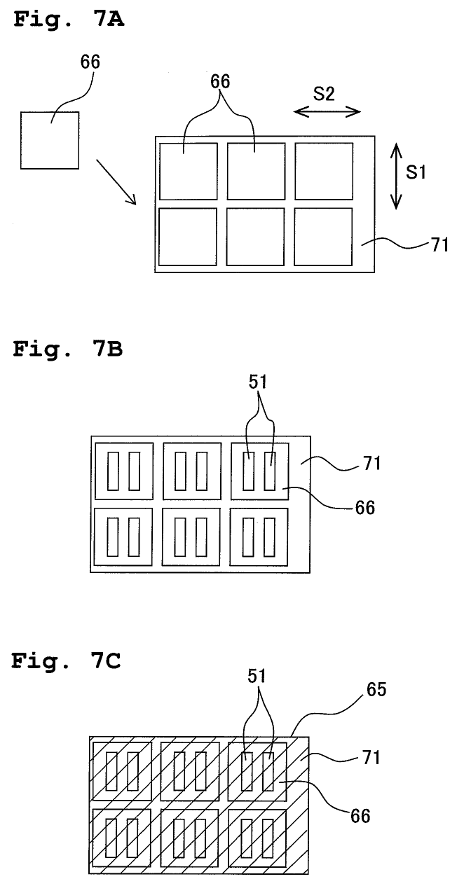

Other than the embodiment, as shown in FIG. 7A, the resin plate base material 61 is cut into the base materials 66 of a predetermined shape and size. Then, the base materials 66 are attached, based on the positioning marks, to a metallic member 71 which is considerably greater in area than the base material 66 (in this case, masking, i.e., a back surface protection film, is applied to the back surface of the metallic member 71 for preventing contamination). Thereafter, it is possible to apply a polyimide resin while being positioned with a predetermined pattern by the liquid droplet discharge method to form the projecting portions 51 which will be then calcinated and solidified. In this case, later, a temporary calcination is carried out after the liquid repellent film 65 is formed all over the nozzle surface, and a main calcination is carried out after the back surface protection film is detached. This is because the main calcination is carried out at about 250° C., which may consequently undermine the back surface protection film in thermostability. Then, in the same manner as described hereinbefore in the embodiment, the surface protection film 74 is attached, and the nozzle holes are formed by laser processing.

In the embodiment, explanations are given with respect to manufacturing a nozzle plate for the ink jet recording apparatus as the liquid droplet discharge apparatus. However, the prevent invention is not limited to this but may be applied to manufacturing nozzle plates utilized in other liquid droplet discharge apparatuses such as those for applying coloring liquids in minute liquid droplets, forming wiring patterns by discharging conductive liquids, etc.

In the embodiment, a piezoelectric method is applied to the drive portions for discharging the inks (liquids). However, other than the piezoelectric method, it is possible to apply the present invention to manufacturing nozzle plates for the liquid droplet discharge apparatuses which carry out the discharge operation by electrostatic or electric heating elements.

In the embodiment, the recording medium is a sheet of recording paper. However, other than that, various materials may be utilized such as resins, fabrics, and the like. Further, as the discharge liquids, not only inks but also various other liquids such as coloring liquids, functional fluids, and the like may also be applied.

In the embodiment, the projecting portions 51 are formed to be inside the suction cap, that is, to be apart from the portions for connection with the suction cap. However, this is not limited to the suction caps utilized in recovery devices for recovering discharge performance but may be applied as well to sealing caps utilized when the power is off.

What is claimed is:

1. A nozzle plate manufacturing method for manufacturing a nozzle plate in which a plurality of nozzle holes are formed, the method comprising:
adhering a plurality of liquid droplets formed of polyimide resin to one surface of a substrate at portions in the vicinity of portions which are provided for formation of the nozzle holes;
hardening the liquid droplets to form projecting portions;
forming a liquid repellent film on the one surface of the substrate; and
forming the nozzle holes through the substrate.

2. The nozzle plate manufacturing method according to claim 1, wherein the nozzle holes are formed after the projecting portions and the liquid repellent film are formed.

3. The nozzle plate manufacturing method according to claim 2, wherein the nozzle holes are formed, in the substrate, as a plurality of nozzle rows each of which extends in a predetermined direction; and each of the projecting portions extends in the predetermined direction at one of portions between portions at which the nozzle rows are to be formed.

4. The nozzle plate manufacturing method according to claim 3, wherein each of the projecting portions is formed in a form of a dashed line.

5. The nozzle plate manufacturing method according to claim 3, wherein the liquid droplets are adhered to the one surface of the substrate by performing printing in which the liquid droplets are discharged from a discharging apparatus having a plurality of discharge holes.

6. The nozzle plate manufacturing method according to claim 5, wherein positioning marks for the nozzle holes are also formed together with the projecting portions by the printing.

7. The nozzle plate manufacturing method according to claim 5, wherein each of the projecting portions is formed by discharging the liquid droplets from the plurality of discharge holes of the discharging apparatus arranged in a short direction of each of the projecting portions.

8. The nozzle plate manufacturing method according to claim 5, wherein the projecting portions are formed by repeated printing in which the printing is repeatedly performed.

9. The nozzle plate manufacturing method according to claim 1, wherein the substrate is preheated before the liquid droplets are adhered to the substrate.

10. The nozzle plate manufacturing method according to claim 1, wherein after the projecting portions and the liquid repellent film are formed, a surface protection film is attached to the substrate on a side of the one surface and a metallic member is attached to the substrate on the other surface of the substrate, the nozzle holes are formed by irradiating a laser from a side of the other surface, and then the surface protection film is detached from the substrate.

11. The nozzle plate manufacturing method according to claim 1, wherein the substrate is a resin substrate formed of a polyimide resin; and
before adhering the liquid droplets to the substrate, the method further comprising:
removing a brittle layer of the resin substrate with an alkaline solution;
applying a surface hydrophilic process to the surface of the resin substrate by atmospheric pressure plasma processing; and
forming a primer layer by applying a primer to the resin substrate.

12. The nozzle plate manufacturing method according to claim 1, wherein the substrate is a metallic substrate.

13. The nozzle plate manufacturing method according to claim 1, wherein a hollow cap is connected to the one surface of the substrate in a detachable manner so as to cover the nozzle holes; and the projecting portions are not formed at a portion, of the substrate, to which the cap is connected.

14. The nozzle plate manufacturing method according to claim 1, wherein an ink is discharged from each of the nozzle holes.

15. A nozzle plate having a plurality of nozzle holes, comprising:
a resin substrate having a surface on which hydrophilic process is performed;
a plurality of projecting portions formed of polyimide resin on the surface of the resin substrate; and
a liquid repellent film which covers the surface, of the resin substrate, on which the projecting portions are formed;
wherein the nozzle holes are formed in the vicinity of the projecting portions through the resin substrate and the liquid repellent film.

16. The nozzle plate according to claim 15, wherein the nozzle holes are formed as a plurality of nozzle rows each of which extends in a predetermined direction; and
each of the projecting portions extends in the predetermined direction at one of portions between the nozzle rows.

17. The nozzle plate according to claim 15, wherein the projecting portions are formed on the surface of the resin substrate via a primer layer intervening therebetween.

18. The nozzle plate according to claim 15, wherein an ink is discharged from each of the nozzle holes.
